(19) United States
(12) Patent Application Publication
(10) Pub. No.: US 2005/0204340 A1
(43) Pub. Date: Sep. 15, 2005

(54) Attribute-based automated business rule identifier and methods of implementing same

(76) Inventors: Michael D. Ruminer, Helena, MT (US); John P. Aviles, Brea, CA (US)

Correspondence Address: Antoinette M. Tease, P.L.L.C., PO Box 51016, Billings, MT, 59105, US

(21) Appl. No.: 10/797,763

(22) Filed: Mar. 10, 2004

(51) Int. Cl. G06F 9/44

(52) U.S. Cl. 717/123

(57) ABSTRACT

A method for identifying which business rules relate to particular segments of source or object code, comprising the steps of identifying a set of business rules, providing each business rule with a business rule unique identifier, and attaching an attribute containing the business rule unique identifier to a segment of code. The method can be used to validate the existence of a business rule at coding time, compile time, or on demand, as well as to query compiled code for a particular business rule. An automated system comprising a set of business rules, a set of business rule unique identifiers, and one or more attributes attached to one or more segments of source or object code, wherein each attribute contains at least one business rule unique identifier. The system can be implemented in connection with any programming language or environment that allows attributes and utilizes reflection.

### CROSS-REFERENCE TO RELATED APPLICATION

This application is an original nonprovisional application. It does not claim priority back to any previously filed patent application.

### BACKGROUND OF THE INVENTION

1. Field of the Invention

The present invention relates to the field of computer software, and more particularly to the use of attributes in source code to create a cross-reference between particular segments of source code and the business rule or rules to which those segments apply.

2. Description of the Related Art

As long as there has been software, there have been business rules in code. In fact, the primary function of business software in the modern world is to incorporate business rules into a controllable and consistent framework for application, thereby increasing efficiency. The software design process has been described as the translation of “requirements into a representation of the software that can be assessed for quality before coding begins.” Roger S. Pressman, Software Engineering: A Practitioner's Approach 21 (2d ed. 1987). The “requirements” are the technical specifications for the software that will implement the business rules.

A business rule is an operational rule that an enterprise uses to conduct its business. As these operations are automated, these rules are transferred from “tribal knowledge” (what is known but generally not reduced to writing), standard operating procedures, or other guidelines to source code in order to apply the same set of rules in an automated fashion. An example of a business rule is “all purchases greater than $10,000 must go through a credit approval process” or “a quote must exist before a sales order can be created.” According to one author, a business rules approach is a methodology by which businesses capture, challenge, publish, automate, and change rules from a strategic business perspective. This same author characterizes the business rules approach as “an appreciation for rules as a valuable asset for a business organization.” Barbara von Halle, Business Rules Applied, Wiley & Sons Publishers (2002).

A business rules system is an automated system in which the business rules are separated and shared across data stores, user interfaces and applications. Barbara von Halle, “Building a Business Rules System,” DM Review Magazine (Jan. 26, 2004). Some commentators have argued that the separation of business rules from source code is necessary in order to further knowledge management. In response to these arguments, business rule engines have been developed to eliminate the necessity of placing business rules into hard coded software. These business rule engines can take the form of table-driven configuration options, rules-based processing, or business rule repositories. The concept of storing operational rules in a repository external to the automation component is not novel. Despite the existence of business rule engines, business rules are inevitably included in source code for various reasons, including efficiency, reduced complexity (i.e., avoiding the complexity of dealing with a business rule engine), and lack of sophistication or infrastructure to support business rule repository structures.

Given the fact that business rules exist in code, there is a need for a mechanism by which the rules can be cross-referenced to the code in which they are implemented. With the growth of multi-layer, distributed systems, implementation of a rule can become more consolidated or more spread out, depending on whether the rule is applied at multiple tiers. For example, a rule could be applied in the presentation layer in validating that the user's data entries comply with the rule. Next, the rule would likely be applied in the class or programmatic structure that handles the type of data covered by the rule. The rule may also be applied at the database layer. Until fairly recently, databases did not have much intelligence as far as business rules are concerned, but the newer database programs that incorporate functions, stored procedures and embedded programs make it possible to implement business rules at the database layer. One example is the forthcoming SQL server from Microsoft Corporation code-named “Yukon” that uses C# for stored procedures. Another example is the forthcoming BIZTALK® Server “Jupiter” that relies heavily on NET for its programmatic strengths.

One of the purported values of the modern distributed systems is the ability to centralize knowledge and rules into discrete operations. With the expansion of increased feature sets and the calling of systems from other disparate and universal systems, however, the rules are often applied in many different locations to ensure integrity. Comments in the code are typically used to make a note of when some specific logic is utilized, but no mechanism currently exists that cross-references a segment of source code to the business rule or rules it implements. The present invention contemplates the use of metadata, or attributes, to link source code and object code to business rules in programming languages that utilize reflection.

Metadata is information about information. It facilitates automation by providing a reference to certain other information. An obvious example of metadata is a table of contents. The table of contents is metadata in that it provides a reference to underlying information. Another example of metadata is an index on a database table. Many programming languages, especially the more modern ones, contain structures for metadata. One could argue that every programming language contains a structure for metadata in the form of comments, but comments are relevant only to humans and not to computers; therefore, they are excluded from the present discussion of metadata structures. As systems become more “intelligent” and can handle tasks such as monitoring themselves for exceptions, metadata becomes more important. One of the most visible and growing uses of metadata is the use of metadata in XML as a means to create a myriad of metadata documents and protocols, including WSDL and XSD.

The power of metadata becomes apparent in the context of reflection. Reflection allows the programmatic runtime evaluation of metadata on code that is compiled, even if it is running concurrently with the evaluation, and even on the code that is responsible for executing the investigation of the metadata. Through the use of reflection, a program can be coded to evaluate runtime conditions and base actions on responses that may not have been known at compile time. In addition, parts of code that did not exist at compile time can actually be built, called and run. Some of the programming languages that utilize reflection are C# (which is the language in which the prototype of the present invention has been built), C++.NET, and Java.

Attributes provide a mechanism for attaching declarative information to a code element, and they can be accessed in the code through the use of reflection. Technically, attributes are descriptors that create additional metadata for the code. By way of example, the C# programming language enables programmers to specify declarative information about the entities defined in the program, and it also allows programmers to invent new kinds of declarative information (i.e., attributes). Programmers can then attach attributes to various program entities and, through the use of reflection, retrieve attribute information in a run-time environment. Attributes are attached to a code element by preceding the code element with a reference to the attribute and providing any relevant parameters or flags. This call to the constructor is placed within angle brackets [symbol] in Visual Basic and regular brackets [ ] in C#. By convention, all attribute classes end in “Attribute,” although several languages that target the common language runtime, including Visual Basic and C#, do not require the full name of the attribute. See “Attributes” and “Providing Metadata Descriptions About Your Component,” Microsoft.com MSN Library (February 2004).

By utilizing attributes, the characteristics of program members can be indicated, and by using reflection on those attributes, the characteristics of the members can be acted upon to adjust the process flow or logic in other code. As is specifically addressed herein, attributes can also be utilized to draw a connection between an external data source and the program members. The novelty of the present invention lies in its use of attributes as a cross-reference between business rules and the source code that implements those rules. Through the use of the present invention, programmers can ascertain quickly and efficiently through a simple query what changes need to be made to the source code as a result of a change in a business rule. The use of business rule engines that access a business rule repository is not new, but tying business rules directly to the source code through the use of attributes, so that the business rules database can be modified without exiting the development environment, is novel and will greatly facilitate the development of software that implements changing business rules.

Any dynamic business environment will present changing business rules. By increasing the efficiency of automation in such an environment, the present invention impacts not only the software development world but also the business world generally by enabling systems to change with the speed of business.

### BRIEF SUMMARY OF THE INVENTION

The present invention is a method for identifying which business rule or rules relate to a certain segment of source or object code, comprising the steps of identifying a set of business rules, providing each business rule with a business rule unique identifier, and attaching an attribute containing the business rule unique identifier to a segment of code. The method of the present invention can be used to validate the existence of a business rule at coding time, compile time, or on demand, as well as to query compiled code for a particular business rule. The business rules may or may not be contained within a business rule repository. Optionally, a business rule source code cross-reference plug-in can be used to add a business rule that is represented by a particular business rule unique identifier to the business rule repository, and a business rule source code cross-reference index can be used to store metadata on the relationships between certain segments of source or object code and the business rules.

In addition to the method claims, the present invention includes an automated system comprising a set of business rules, a set of business rule unique identifiers, and one or more attributes attached to one or more segments of source or object code, wherein each attribute contains at least one business rule unique identifier. The system can be implemented in connection with any programming language or environment that allows attributes and utilizes reflection. The system optionally includes a business rule source code cross-reference plug-in, which communicates with external applications such as an IDE. The system may also include a business rule source code cross-reference index, a cross-reference search tool, and a business rule source code cross-reference engine.

The business rule source code cross-reference engine comprises a compiled object code verifier, a compiled object code indexer, a source code verifier, an index query engine, and a compiled object code query engine. The compiled object code verifier takes compiled attributed object code and verifies as a post-compile process the existence of a particular business rule according to the attributes within the object code. The compiled object code indexer indexes to a repository the attributes in the object code. The source code verifier takes source code segments, parses out the attributes from the source code, and validates the attributes. The index query engine provides result sets based on given criteria as compared against the business rule source code cross-reference index. The compiled object code query engine performs one or more searches against compiled attributed object code and returns a result set based on the attribute metadata and the search criteria.

### BRIEF DESCRIPTION OF THE DRAWINGS

FIG. 1 is a block diagram showing the structure of a system for implementing the present invention.

FIG. 2 is a short section of code written employing attributes according to the present invention.

FIG. 3 is a block diagram showing the structure of a sub-system for implementing a portion of the present invention.

FIG. 4 is a flowchart showing a method for carrying out a sub-system of the present invention.

FIG. 5 is a flowchart showing a method for carrying out the present invention with source code in an integrated development environment.

FIG. 6 is a flowchart showing a method for carrying out the present invention with object code from within an integrated development environment.

FIG. 7 is a flowchart showing a method for carrying out the present invention through the use of a search tool with object code and index queries.

FIG. 8 is a flowchart showing a method for carrying out the present invention through the use of a source code parser.

FIG. 9 is a flowchart showing a method for carrying out the present invention through the use of a source code control system.

FIG. 10 is a block diagram showing the structure of a system for implementing the present invention with various applications.

### DETAILED DESCRIPTION OF INVENTION

The present invention provides programmatic and attribute-based cross-referencing of source code to business rules. This type of cross-referencing tool currently does not exist. In the vast majority of enterprises today, business rules are encapsulated in the source code with no comprehensive or reliable method of tracking which business rules are located in which segments of source code. The present invention makes a direct connection between business rules and source code through the use of attributes. By providing information about relationships between source code and business rules, the present invention allows the metadata information to be used in a more dynamic way than it ever has been used in the past. Specifically, the present invention not only makes it easier for developers to make changes in the source code that are necessitated by changes in the business rules, but it also makes possible a whole host of automated processes based on these relationships. As is more fully described below, the present invention allows validation of the existence of a business rule at compile time, at real-time edit, or on demand.

The following detailed description of preferred embodiments refers to the accompanying drawings and shows by way of illustration specific embodiments of the present invention. Structural, logical and procedural modifications within the spirit and scope of the invention will occur to those skilled in the art. The following description is therefore not to be taken in a limiting sense.

### Example of a System Implementing the Present Invention

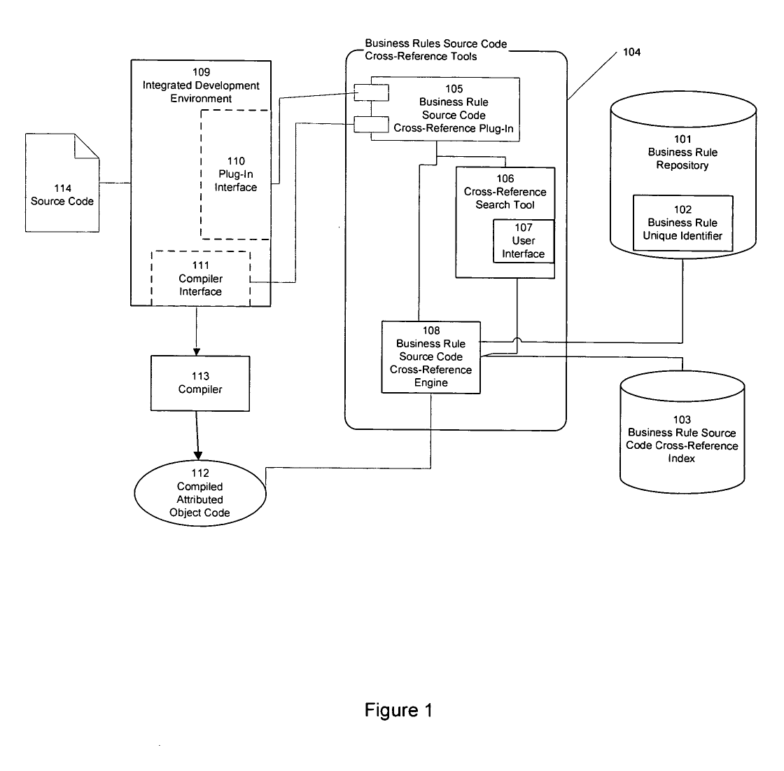

FIG. 1 is a block diagram showing the structure of a system for implementing the present invention. The system includes a business rule repository 101 that contains unique identifiers 102 for the business rule representations. The business rule repository 101 may be any type of repository that stores descriptive data and that utilizes an identifier that is unique for each business rule. The business rule repository 101 may be in the form of XML, databases, text files or other forms of representing or persisting data that are known to those skilled in the art of computer programming. The illustrated system contains a business rule source code cross-reference index 103, which may be used in some implementations of the present invention. The business rule source code cross-reference index 103 provides a repository for storing for future retrieval or query metadata on what source code or object code utilizes the business rules represented in the business rule repository 101.

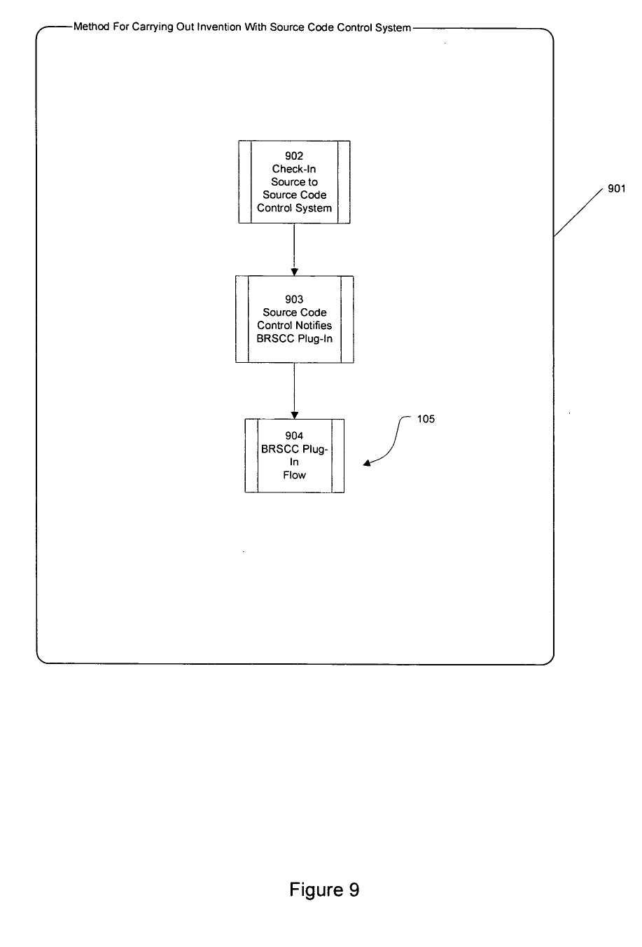

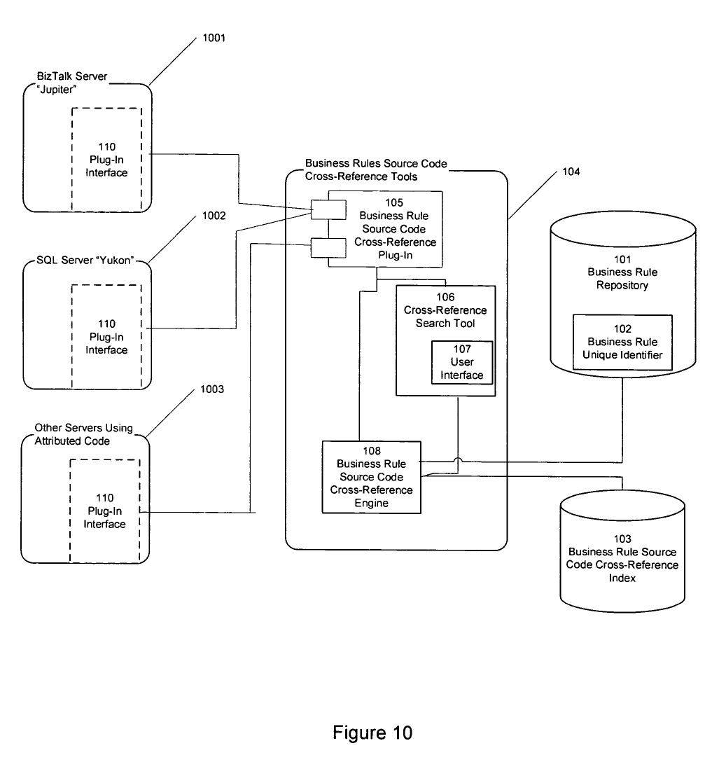

The system illustrated in FIG. 1 also includes an integrated development environment (“IDE”) 109. The IDE 109 consists of a plug-in interface 110 for extension by third party components and a compiler interface 111. The plug-in interface 110 is utilized by the business rule source code cross-reference tools 104. One of these tools is a business rule source code cross-reference plug-in 105. The purpose of the plug-in 105 is to communicate with the IDE 109 via the plug-in interface 110, thus allowing the present invention to be notified of given events. These events would typically include source code compiling and source code additions or edits via the IDE 109. The business rule source code cross-reference plug-in 105 could function in response to events from the plug-in interface 110 or the compiler interface 111 or other events from the IDE 109. The purpose of the business rule source code cross-reference plug-in 105 is to provide an interface to allow the present invention to interact with external applications such as the IDE 109. As illustrated in FIGS. 9 and 10, the present invention can be utilized in connection with applications other than an IDE.

The business rule source code cross-reference engine 108 shown in FIG. 1 interacts with external object code, source code and external applications, as well as the business rule source code cross-reference index 103 and the business rule repository 101, either directly or through the business rule source code cross-reference plug-in 105. In one implementation of the present invention, the business rule source code cross-reference engine 108 operates against compiled attributed object code 112. The object code 112 is a result of the IDE 109 and the compiler 113 acting on the source code 114. The system shown in FIG. 1 also includes a cross-reference search tool 106 and a user interface for that tool 107. The cross-reference search tool 106 may interact with external applications as indicated in FIG. 1 via the business rule source code cross-reference plug-in 105, or it may stand alone.

FIG. 1 represents one possible embodiment of the present invention, but there are many possible implementations of the attribute-based automated business rule identifier provided by the present invention. In FIG. 1, represented connections between components of the present invention, such as between the business rule source code cross-reference engine 108 and the business rule repository 101, can take the form of a number of methodologies known to those skilled in the art, including, but not limited to, network communications, embedded memory maps, and data storage access. Similarly, FIG. 1 depicts a business rule source code cross-reference plug-in 105 for use in interacting with the source code 114 and the object code 112 via an IDE 109, but other methods for interacting with source and object code could be utilized while still remaining within the scope of the present invention.

### Source Code Attributes

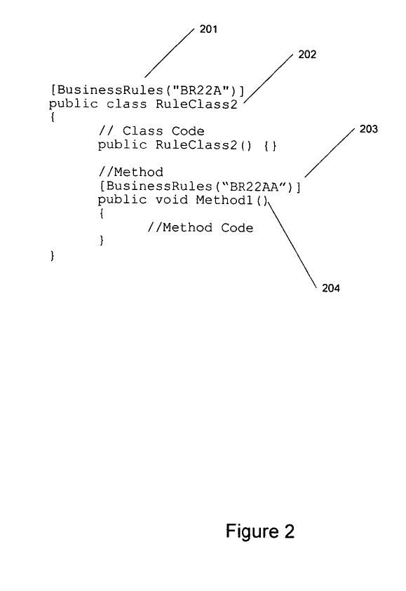

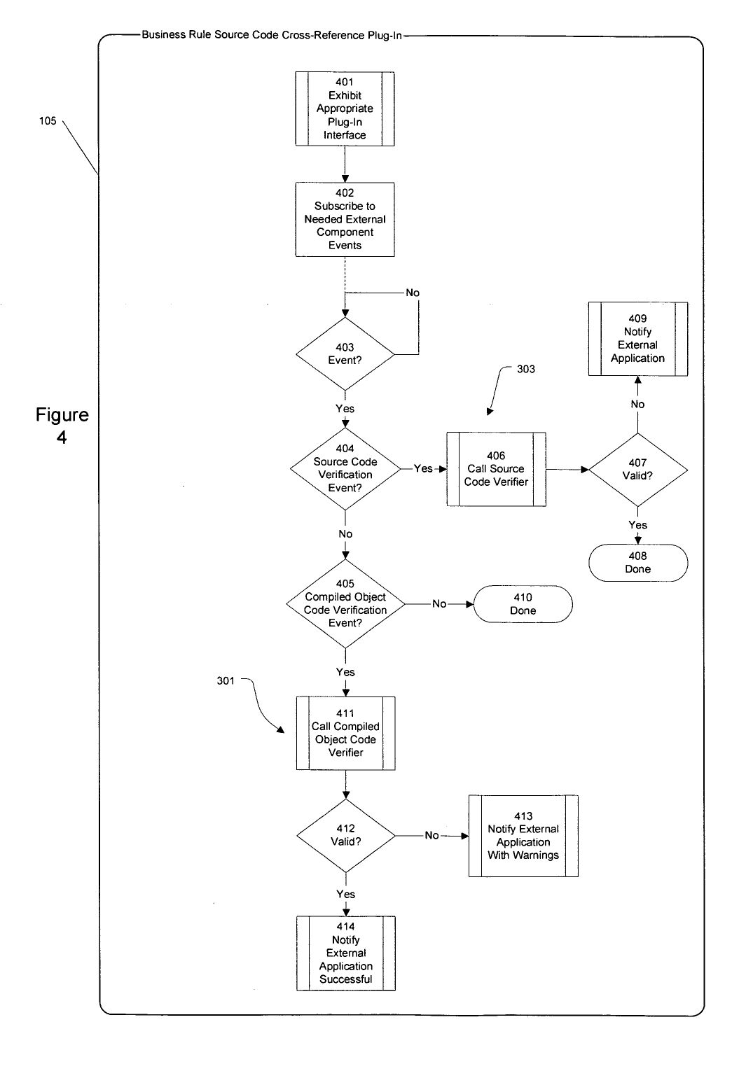

FIG. 2 is a short section of code that serves as an example of the use of a programmatic attribute in the present invention. In this figure, source code attributes 201, 202 are used to provide metadata information on the class 202 and method 204. Ideally, the source code attribute is in the form of metadata within the compiled object code, but attributes may take additional forms depending on the programming language used. In FIG. 2, the name “BusinessRules” denotes the attribute 201, 202. The attribute used in this example accepts a single parameter that represents the business rule unique identifier 102, which is shown in FIG. 1. As further illustrated in FIGS. 4, 5, 6, 7, 8 and 9, this attribute can be utilized in both source code format or in compiled object code metadata to query compiled code for the use of a given business rule or to validate at coding time, compile time or on demand the existence of a matching business rule in the business rule repository 101. A business rule source code cross-reference index 103 may be generated that stores, by means other than directly to source code or compiled object code, the cross-reference of business rules and source code. The code in FIG. 2 provides an example in the C# programming language of the use of attributes within the context of the present invention, but the present invention expressly contemplates that other parameters, signatures and naming choice may be used for the business rule attributes.

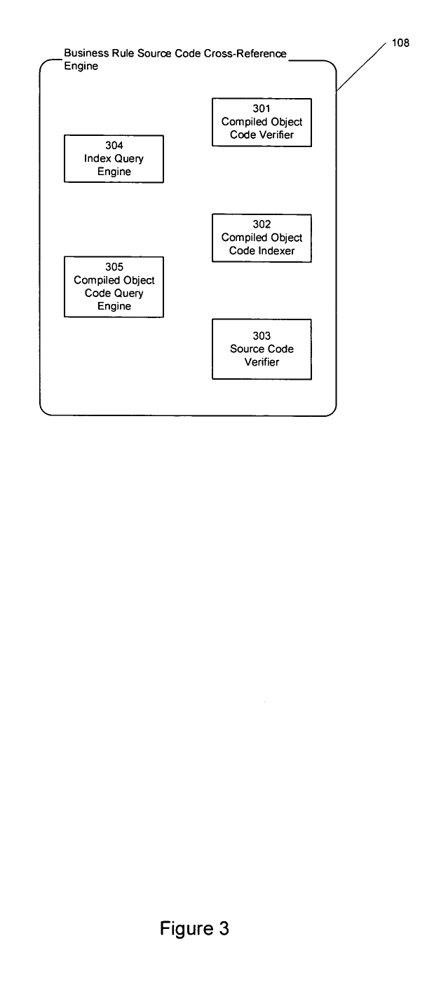

The attributes that are the subject of the present invention are not limited to the metadata description of classes and methods provided as an example in FIG. 2 but can be utilized in any manner for which a language attribute is appropriate and in any system that supports the use of attributes. Examples of other such systems are included in FIG. 10, and methods for additional implementation are provided as examples in FIGS. 3 through 9. Detailed descriptions of language-specific attribute usage can be found within the desired language specification. The present invention is based on the use of attributes to provide metadata representation of business rule implementation locations. In a preferred embodiment of the present invention, each business rule attribute is cross-referenced to an external business rule repository for validation of the existence of the business rule, but the attributes may also be self-contained and have no effect outside of the metadata in which the attribute exists. In the latter scenario, the business rule will likely contain additional parameters in order to be more self-describing of the implemented business rule. An example of the pattern for such a business rule attribute would be:
[BusinessRuleAttribute(Business Rule Unique Identifier, Business Rule Name, Business Rule Description)]

The purpose of the present invention is to allow the indexing of compiled or source code as it relates to business rules, whether those rules exist in external repositories or only within the context of the attribute itself. Attributes have been used to provide metadata information on code segments, both object and source. The novelty of the present invention is in applying attributes to source or object code specifically for the purpose of (i) querying at some time in the future which code segments relate to given business rules or (ii) allowing edit time, compile time or on demand verification of the existence of a business rule in a repository. As used in this patent application, the term “on demand” means at any time other than at edit or compile time.

The present invention provides syntax and reference integrity for purposes of business rule verification. By providing a mechanism for identifying which business rules relate to which segments of code, the present invention also facilitates the future query of code and allows for easier and more thorough maintenance of code when business rules need to be changed. The business rules need not be detailed or specific algorithms; they can be general in the sense of indicating broad or abstract logic implementations in the code. The present invention does require that the business rule attribute contain at least one parameter in the first position. This parameter serves as the business rule unique identifier. Additional attribute parameters may or may not exist, depending on the specific implementation of the present invention. In the preferred embodiment, the unique identifier is cross-referenced to an external business rule repository.

Multiple business rule attributes may be applied to a single section of code because a single section of code may represent any number of business rules, or it may represent further detailed implementation of more general business rules. For example, a section of code that represents how to calculate discounts on invoices may utilize a broad business rule with the identifier “BR100” that states: “Invoices paid on time are always discounted.” That same section of code may also represent a more detailed version of that rule with the identifier “BR100A” that states: “Invoices paid on time are not to be discounted more than ten percent.” The present invention is not limited in terms of the specific means by which the business rules are identified or organized, nor is the present invention limited in terms of the contents or meaning of specific business rules. The present invention relates to the use of attributes to locate sections of code where particular business rules are applied, regardless of what those business rules represent. The attributes may have multiple parameters that provide additional detail outside of the business rule unique identifier. Descriptive parameters, repository names, and namespaces, among other pieces of data, may be used to expand the amount of metadata stored within the attribute.

### Business Rule Source Code Cross-Reference Engine

FIG. 3 is a block diagram showing the structure of a sub-system for implementing a portion of the present invention. FIG. 3 represents the business rule source code cross-reference engine 108, which consists of a compiled object code verifier 301, a compiled object code indexer 302, a source code verifier 303, an index query engine 304, and a compiled object code query engine 305. The purpose of the compiled object code verifier 301 is to take compiled attributed object code and verify as a post-compile process the existence of the referenced business rule according to all the business rule attributes within the object code. The compiled object code indexer 302 serves to index to a repository all business rule attributes in the object code. This indexing allows future lookups to be performed to determine which code segments reference given business rules without having to access the object or source code directly. The source code verifier 303 performs tasks similar to those performed by the compiled object code verifier 301, with the exception that the source code verifier 303 provides validation on the source code itself and acts in many instances as a pre-compiler, edit-time check on the source code.

The index query engine 304 provides result sets for given criteria as compared against the business rule source code cross-reference index 103 (see FIG. 1). The compiled object code query engine 305 performs a search against compiled attributed object code and returns a result set based on the business rule attribute metadata and the search criteria.

FIG. 4 is a flowchart showing a method for carrying out a sub-system of the present invention. More specifically, FIG. 4 provides further detail regarding the business rule source code cross-reference plug-in 105 shown in FIG. 1. Methods of interaction with external systems and methods of utilization of the present invention via a plug-in other than that illustrated in FIG. 4 can be used and are within the scope of the present invention. The block marked “Exhibit Appropriate Plug-In Interface” represents the interface that the plug-in must exhibit in order to interact with the external application in accordance with the published standards and Application Programming Interface (“API”) of the external application. The building of these interface and plug-in adapters is well known to those skilled in the art.

The block marked “Subscribe to Needed External Component Events” represents the interaction of the plug-in with the external application to which the plug-in has been adapted. It is usual and customary for plug-ins to subscribe to events of the external application in order to take action based upon those events. The dotted line between blocks 402 and 403 represents such an event-driven process and indicates an asynchronous type of communication in which 403 waits for an event from the hosting external application. Once a subscribed event is fired, process flow within the plug-in moves to 404. For purposes of the example shown in FIG. 4, object code verification and source code verification are the only types of events; however, the particular events may differ based upon the exact implementation and the external application with which the plug-in is utilized, and the present invention is not limited to any particular type of event. Examples of various external applications with which the present invention can be utilized are provided in the figures, and any number of actual events within these individual applications may be processed to represent the demonstrated source code verification or object code verification events.

The block marked “Source Code Verification Event?” indicates a decision point in which flow is controlled based upon the type of event. If the event is a source code verification event, then the decision point 404 would evaluate to true, and flow would go to 406. At 406, the source code verifier 303 is called. Decision point 407 determines whether the return indicates “valid” for the source code verification event. The return will indicate “valid” if all the business rule attributes within the source code have been verified. Depending on how the present invention is implemented, “valid” could mean that the business rule attribute in the source code is well formed and usable, or, as is likely to be the case in most implementations, it could mean that the business rule exists in the business rule repository 101 as identified by the business rule unique identifier 102. A result of “valid” in 407 will send the flow to 408, which represents the end of the flow for this event. In other implementations of the present invention, a return of “valid” at 407 could result in a return via the plug-in, logging, further events or additional flow control. FIG. 4 is not intended to represent the only method of implementing the present invention and its results, outcomes and flow. If the return at the decision point 407 is “not valid,” then flow moves to 409, and the external application is notified via the published methodology for that application.

If decision point 404 were not a source code verification event, then flow control would move to 405, which is an additional decision point for a compiled object verification event. The flow diagram of FIG. 4 is a logical, linear and synchronous representation of a non-linear and asynchronous event. In most modern languages, evaluation of the events in 404 and 405 is not done in a linear fashion (as suggested by this figure) but through event-driven notification. The present invention is not limited in terms of whether evaluation is conducted in a linear or non-linear manner. In an asynchronous (i.e., non-linear) implementation, the flow to 410 typically would not occur because the plug-in would only be notified of the events in which it was interested. If the event is an object code verification event, then flow control would move to 411. An object code verification event is an event in which one or more segments of compiled attributed object code is/are presented for verification.

At 411, the compiled object code verifier 301 is called. Upon the return from the compiled object code verifier 301, the decision point 412 is evaluated. As discussed above in connection with decision point 407, the definition of “valid” varies depending on the implementation. The criteria applied at 412 to determine whether a result is “valid” could be the same as or different than the criteria applied at 407. For example, in one implementation of the present invention, a “valid” result could be generated at 406 if the source code business attribute is well formed, but a “not valid” result could be returned at 412 because not all of the business rule unique identifiers referenced in the metadata are contained in the business rule repository. Depending on the return of “valid” or “not valid,” flow control will move from 412 to 414 or 413, respectively.

The return values indicated in FIG. 4 and in all of the other figures and corresponding discussions are meant to abstractly represent a comparable value. The actual return may be any of a number of representative values such as “true/false,” “0/1,” or even more analog indications that represent how “valid” the analysis of the metadata turned out to be, for example, “valid with errors” or “valid with warning.”

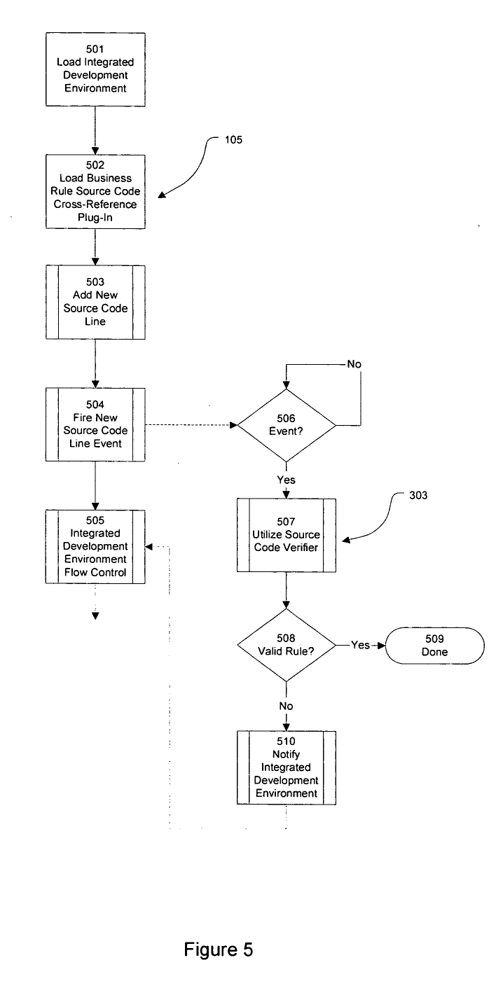

FIG. 5 is a flowchart showing a method for carrying out the present invention with source code in an integrated development environment. The block marked “Load Integrated Development Environment” 501 represents loading the IDE for use on a computer. The block marked “Load Business Rule Source Code Cross-Reference Plug-In” 502 represents the loading of the plug-in by the IDE in accordance with its documented plug-in procedures. Block 502 essentially represents the same process as in 401 and 402 of FIG. 4. Block 503 represents the addition of a new source code line to the IDE. The method for creating event notifications from the IDE based on source code entry both by keystroke and by line(s), among other methods, is well known to those skilled in the art. The creation of event notifications is commonly used in order to provide immediate feedback and to assist the programmer as he writes the code (for example, conducting “on the fly” analyses of the source code for errors and syntax).

In this implementation of the present invention, the entry of new code in the IDE will trigger an event as indicated in 504, and that event will be accessible to the business rule source code cross-reference plug-in 105. The dotted line between 504 and 506 indicates an asynchronous event-driven communication and flow control, as opposed to a synchronous flow. Synchronously in 505, the IDE continues to perform its normal synchronous and additional asynchronous tasks as directed by the user. In 506 the business rule source code cross-reference plug-in 105 is waiting for a source code verification event. In this example, the source code verification event is the result of a new business rule attribute being keyed into the IDE source code. The new source code is then checked at 507 for validity, using the source code verifier 303 that has been previously described.

As explained previously in connection with 407 in FIG. 4, the result of “valid” at 508 can have multiple meanings depending on implementation and environment. It is well known in the art that immediate feedback can be provided within an IDE upon source code entry. In connection with the present invention, a business rule unique identifier can be verified as existing in the business rule repository as it is entered via the IDE into the source code. Optionally, the business rule source code cross-reference plug-in 105 can be used to perform basic operations against the business rule repository, such as adding the business rule that is represented by the business rule attribute to the business rule repository. If the business rule is indicated as “valid” at 508, then the flow moves to 509. If the decision point at 508 returns as “not valid,” then the flow moves to 510. In this example, the IDE is notified via the business rule source code cross-reference plug-in 105 of the “not valid” result. Depending on the specific implementation of the API for the tool to which the plug-in is attached, the IDE may also be notified of a “valid” result. For both 509 and 510, any number of flow control processes, including, but not limited to, other plug-ins, could be utilized.

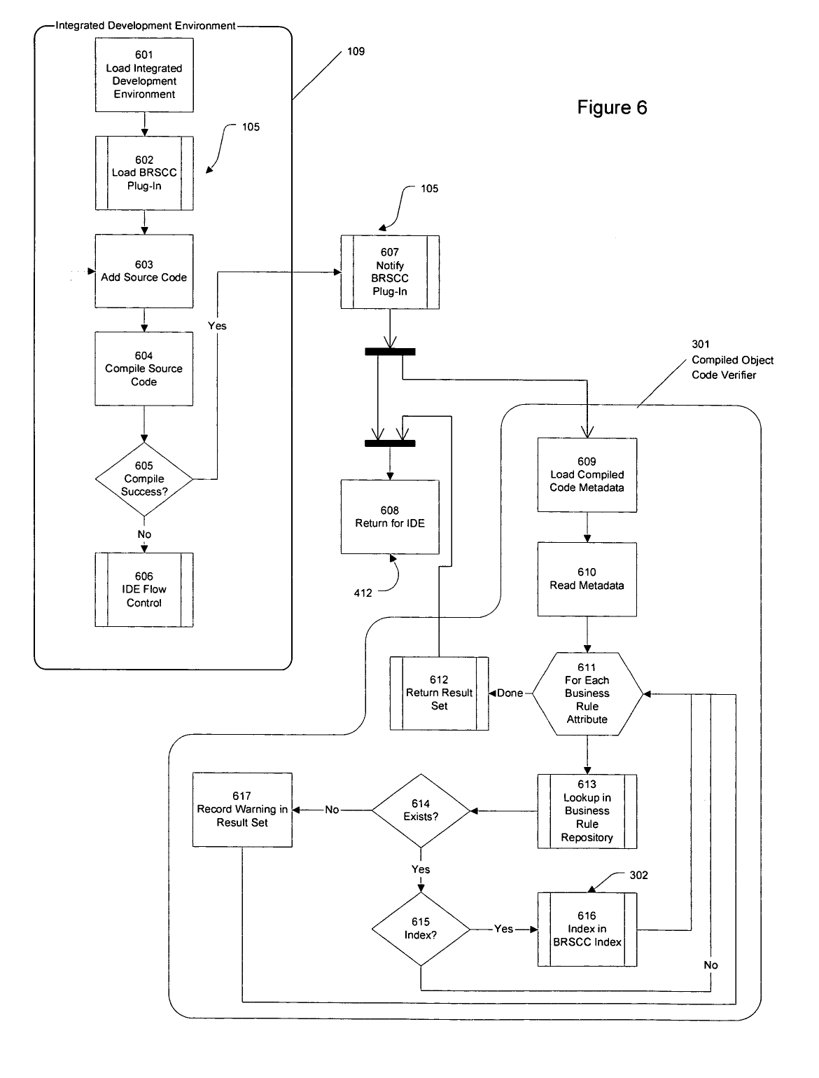

FIG. 6 is a flowchart showing a method for carrying out the present invention with object code from within an integrated development environment. The basic components represented in FIG. 6 are the IDE 109, the business rule source code cross-reference plug-in 105, and the compiled object code verifier 301. In this method, the source code is compiled via the IDE. Upon successful compilation, the business rule source code cross-reference plug-in 105 receives notification from the external application (the compiler or the IDE) and notifies the compiled object code verifier 301. The compiled object code verifier 301 then verifies the metadata in the object code and returns the results to the IDE via the plug-in 105.

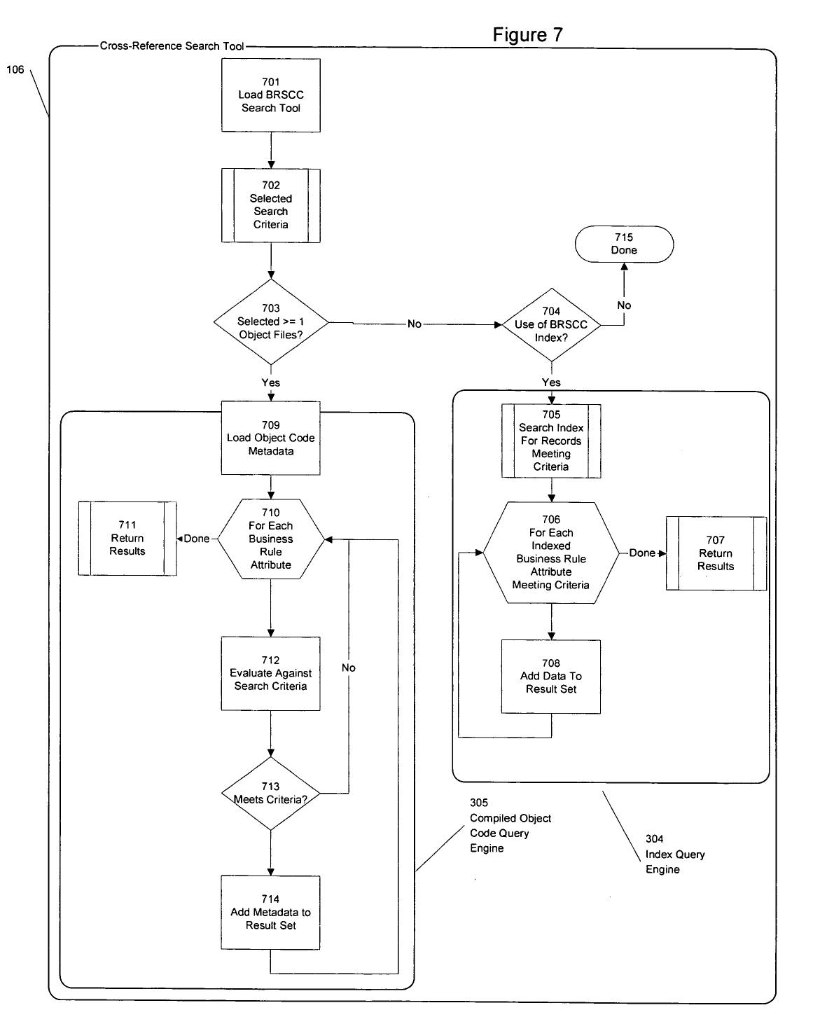

The process begins with 601, when the IDE is loaded on the computer. In accordance with the plug-in protocols of the IDE or as an integral part of the IDE, the business rule source code cross-reference engine 108, which contains the compiled object code verifier 301, is loaded. In the example illustrated in FIG. 7, the IDE is loaded via the business rule source code cross-reference plug-in 105. The business rule source code cross-reference plug-in is loaded at 602. As mentioned above, the present invention may be integral to a particular application and is not restricted to use as a plug-in or other external methods. In fact, the present invention can be utilized inside any application that deals with source or object code that can contain metadata on the code itself.

Block number 603 indicates the usual and customary editing of source code within the IDE. Once the source code is compiled as represented in 604, the typical and standard IDE responses for successful or unsuccessful compile are performed at 605, and if unsuccessful, normal flow control in accordance with the IDE is implemented at 606. Once the compile is completed successfully, 605 will evaluate to some representation of “true,” an event of a successful compile will be fired to the business rule source code cross-reference plug-in, and flow control will shift to 607. At block number 607, the compiled object code verifier 301 is called for a verification of the compiled attributed object code generated from the IDE.

The compiled object code verifier 301 is further broken down in FIG. 6. In block 609, the compiled code metadata is loaded. At 610 the metadata is read, and at 611 the compiled object code verifier 301 begins to handle each occurrence of a business rule attribute in the metadata. At 613 the compiled object code verifier looks for the business rule unique identifier 102 in the business rule repository. Other means of compiled object code verification could be implemented within the scope of the present invention. The decision point at 614 evaluates to true or false depending on whether the business rule unique identifier for the subject business rule attribute was found in the business rule repository. If 614 returns “false,” then flow moves to 617, which will record the false result as part of the result set. Flow control returns to 611 for the next iteration. If 614 returns “true,” then flow moves to 615. Block 615 is a decision point based upon whether indexing of the business rule unique identifier and the code segment should be stored in an external compiled object code indexer 302 for reference, lookup and query without having to access the source or object code. If 615 evaluates to “false,” then flow control returns to 611 for the next iteration. If 615 evaluates to “true,” then the external indexing process is run by the compiled object code indexer 302 at block 616, and flow control returns to 611 for the next iteration.

Upon completion of the handling of each business rule attribute in the metadata, a return result set is created in 612 for return to the business rule source code cross-reference plug-in 105, which then returns the appropriate responses to the IDE as indicated in 608. Ideally, the results returned to the IDE show up in the same or similar location as the compiler output and are treated as a post-compile process. How and with what degree the results are returned, as well as how they are handled after return, are dependent upon the IDE, the business rule source code cross-reference plug-in, and the communications between the IDE and the plug-in. FIG. 6 illustrates one method of implementing the present invention but is not the only logical method.

FIG. 7 is a flowchart showing a method for carrying out the present invention through the use of a search tool with object code and index queries. Specifically, FIG. 7 illustrates one embodiment of the cross-reference search tool 106 shown in FIG. 1. The function of the cross-reference search tool 106 is to enable, through the use of the present invention, the querying and finding which code segments utilize given business rules. These business rules may or may not exist in a business rule repository. As a result of the query, a result set of references to code segments is returned. The query allows for the use of compiled attributed object code to search for given business rules or the use of the business rule source code cross-reference index 103 (FIG. 1). Many different means of returning valid responses from the query could be utilized, and the present invention is not limited to any particular implementation of achieving result sets.

The novelty of the present invention lies in the ability to index and query the metadata of the code for business rule relationships based upon business rule attribute code. The query could be programmed by those skilled in the art to return the actual source code or simply return a reference to which code segments are attributed in accordance with the search criteria. In FIG. 7, block number 701 represents the loading of the search tool. Block number 702 indicates acceptance of the search criteria. This acceptance could take place from a user interface 107 (FIG. 1) or be passed to the search tool via any number of methodologies. The search criteria could, and in many cases would, be based upon a specific set of business rule unique identifiers 102 or some form of pattern matching of business rule identifiers or other business rule attribute parameters that may have been established.

Those skilled in the art of search criteria can perceive many ways to query the metadata that is stored based upon the implementation of the business rule attributes. In the example provided in FIG. 7, the search tool allows one or more object files to be searched or the business rule source code cross-reference index 103 to be selected. Block 703 represents this decision point. If the decision point 703 evaluates to “false,” then no object files were selected, and flow moves to 704. At 704, an evaluation is performed to determine whether the business rule source code cross-reference index 103 was selected as the search source. If decision point 704 evaluates to “false,” then the process in this example is complete, and flow moves to 715. If 704 evaluates to “true,” then flow moves to the index query engine 304.

Within the index query engine 304, block 705 represents a search of the business rule source code cross-reference index 103 for data that matches the search criteria as specified in 702. Block 706 represents a loop for handling each record returned from the index that meets the search criteria. In 708 the data stored in the index 103 is added to the result set. The data that is added to the result set is information about the metadata of previously indexed business rule attributes, i.e., metadata about metadata. Upon completion of iterations through the search results, the flow moves to 707, in which the results are returned for handling by the calling routine. If decision point 703 evaluates to “true,” then flow moves to process 305, which is the compiled object code query engine. The compiled object code query engine 305 takes compiled object code and provides a result set of the metadata based upon the search criteria. Block 710 begins a loop for evaluating each business rule attribute within the metadata. Block 712 evaluates the current business rule attribute values from this iteration using the search criteria specified in 707. If the business rule attribute matches the search criteria, then 713 evaluates to “true,” the metadata is added to the result set in 714, and flow control proceeds through additional iterations of the loop. If 713 evaluates to “false,” then flow returns to 710 for repeated iterations. When all business rule attributes have been evaluated, flow moves to 711, in which the result set is returned for handling to the calling routine.

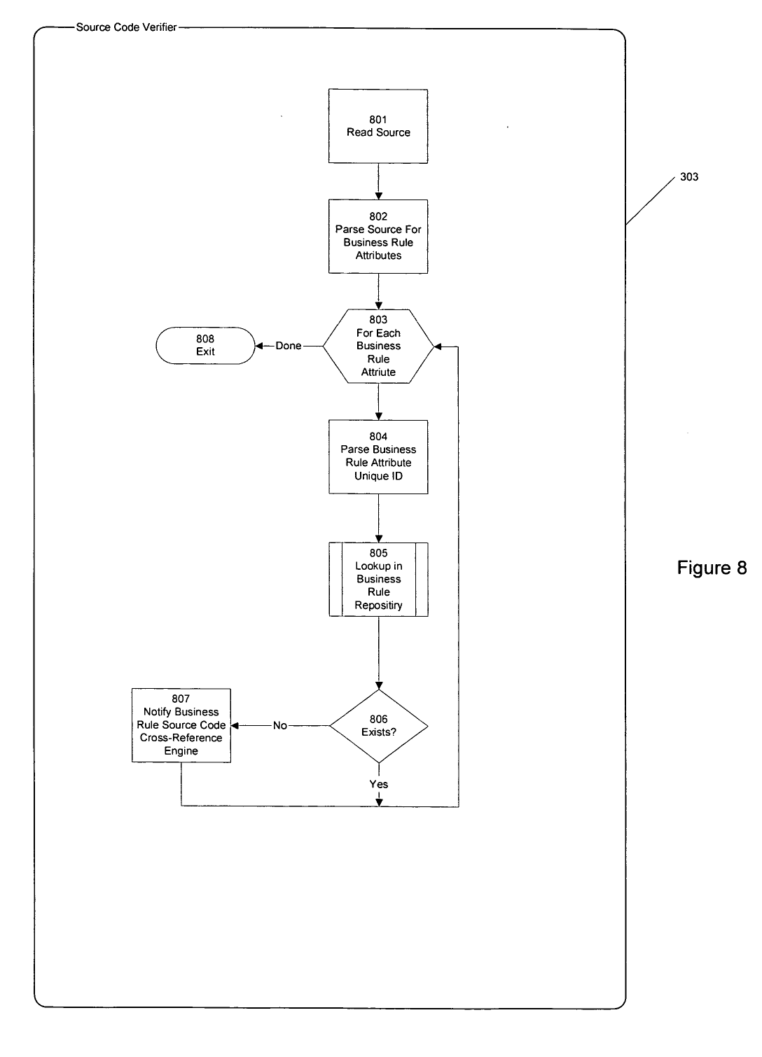

FIG. 8 is a flowchart showing a method for carrying out the present invention through the use of a source code parser. The purpose of the source code verifier 303 is to take source code segments, parse out the business rule attributes from the source code, and validate the business rule attributes. In this example, business rules are stored in a business rule repository 101, each business rule has a business rule unique identifier 102, and validation of a business rule attribute entails confirming that a business rule with a particular business rule unique identifier 102 exists in the repository 101. As mentioned previously, the definition of a “valid” business rule attribute may be different depending on the actual implementation of the present invention in other processes.

In the example provided in FIG. 8, the source code is read into the process at block 801. At 802, the source code is parsed for business rule attributes. Block 803 represents the beginning of an iterative loop for handling each business rule attribute within the source code loaded at 801. With each iteration of the loop, flow moves into 804, which parses out the business rule unique identifier 102. At block 805, this business rule unique identifier 102 is looked up in the business rule repository 101. Decision point 806 evaluates to “true” if the business rule unique identifier 102 is located in the business rule repository 101. In this implementation of the present invention, a verified and valid business rule attribute does not require any feedback to the calling system, and thus a “true” evaluation at decision point 806 allows the next iteration of the loop to proceed. If decision point 806 evaluates to “false,” then the calling routine is notified at block 807. In this illustration, the calling routine is assumed to be some other part of the business rule source code cross-reference engine 108, but the present invention is not limited to a particular implementation of the calling routine. Flow continues to move through the next iteration of the loop via 803 until all the business rule attributes have been parsed, in which case flow moves to 808, and flow control returns to the calling routines.

FIG. 9 is a flowchart showing a method for carrying out the present invention through the use of a source code control system. In this figure, the source code control system 901 is assumed to be using a business rule source code cross-reference plug-in 105 for communications with the business rule source code cross-reference tools 104. The example depicted in this figure is only one method of implementing the present invention for source code control but is representative of a pattern that can be applied to many external application implementations. For example, the present invention could be carried out via embedded processes or web services or other means known to those skilled in the art.

The block marked “Check-In Source to Source Code Control System” 902 signifies the broad, abstract process of checking source code into a source code control system. At block 903, a business rule source code cross-reference plug-in 105 that is specific to the source code control system being utilized is notified that the source code has been checked in. Flow them moves through 904 for handling of the business rule attributes that may exist in the source code, as further explained in connection with FIG. 4.

FIG. 10 is a block diagram showing the structure of a system for implementing the present invention with various applications. The external applications shown in this FIGS. 1001, 1002 and 1003 interact with the present invention in a similar manner as the IDE 109 shown in FIG. 1. Those skilled in the art will find many applications 1003 in which the attribute-based automated business rule identifier of the present invention can be utilized. FIG. 10 shows only a couple of these applications. For example, the “Jupiter” version of BIZTALK® Server 1001 utilizes compiled attributed .NET object code; therefore, the present invention can be implemented in connection with BIZTALK® Server for indexing, querying and cross-referencing source and object code. Similarly, the “Yukon” version of Microsoft SQL Server 1002 utilizes attributed object code for user-defined implementations and can be used to implement the present invention.

The many features and advantages of the present invention are apparent from the detailed specification, and the appended claims are intended to cover all such features and advantages. Because numerous modifications will readily occur to those skilled in the art, the present invention is not limited to the exact construction and operation illustrated and described herein, but rather encompasses all such modifications and equivalents.

1. A method for identifying which business rule or rules relate to a certain segment of source or object code, comprising the steps of:
(a) identifying a set of business rules;
(b) providing each business rule with a business rule unique identifier; and
(c) attaching an attribute to a segment of code, wherein the attribute contains the business rule unique identifier.

2. The method of claim 1, further comprising the step of validating the business rule at coding time.

3. The method of claim 1, further comprising the step of validating the business rule at compile time.

4. The method of claim 1, further comprising the step of validating the business rule on demand.

5. The method of claim 1, further comprising the step of validating at coding time the existence of a business rule.

6. The method of claim 1, further comprising the step of validating at compile time the existence of a business rule.

7. The method of claim 1, further comprising the step of validating on demand the existence of a business rule.

8. The method of claim 1, further comprising the step of querying compiled code for the use of a given business rule.

9. The method of claim 1, wherein the business rules are contained in a business rule repository.

10. The method of claim 9, further comprising the step of utilizing a business rule source code cross-reference plug-in to add a business rule that is represented by a particular business rule unique identifier to the business rule repository.

11. The method of claim 1, further comprising the step of utilizing a business rule source code cross-reference index to store metadata on the relationships between certain segments of source or object code and the business rules.

12. An automated system comprising:
(a) a set of business rules;
(b) a set of business rule unique identifiers, wherein each business rule unique identifier corresponds to one and only one business rule; and
(c) one or more attributes attached to one or more segments of source or object code, wherein each attribute contains at least one business rule unique identifier.

13. The automated system of claim 12, further comprising a business rule source code cross-reference plug-in.

14. The automated system of claim 13, further comprising an integrated development environment (IDE) with a plug-in interface, wherein the business rule source code cross-reference plug-in communicates with the IDE via the plug-in interface.

15. The automated system of claim 12, further comprising a business rule source code cross-reference index.

16. The automated system of claim 12, further comprising a business rule source code cross-reference engine.

17. The automated system of claim 16, wherein the business rule source code cross-reference engine comprises a compiled object code verifier, a compiled object code indexer, a source code verifier, an index query engine, and a compiled object code query engine.

18. The automated system of claim 17, wherein the compiled object code verifier takes compiled attributed object code and verifies as a post-compile process the existence of a particular business rule according to the attributes within the object code.

19. The automated system of claim 17, wherein the compiled object code indexer indexes to a repository the attributes in the object code.

20. The automated system of claim 17, wherein the source code verifier takes source code segments, parses out the attributes from the source code, and validates the attributes.

21. The automated system of claim 17, further comprising a business rule source code cross-reference index, wherein the index query engine provides result sets based on given criteria as compared against the business rule source code cross-reference index.

22. The automated system of claim 17, wherein the attributes contain metadata, and wherein the compiled object code query engine performs one or more searches against compiled attributed object code and returns a result set based on the attribute metadata and the search criteria.

23. The automated system of claim 12, further comprising a cross-reference search tool and a user interface for the cross-reference search tool.

24. The automated system of claim 23, wherein the cross-reference search tool interacts with external applications.

25. A computer readable medium having computer executable instructions for performing the acts recited in claim 2.

26. A computer readable medium having computer executable instructions for performing the acts recited in claim 3.

27. A computer readable medium having computer executable instructions for performing the acts recited in claim 4.

28. A computer readable medium having computer executable instructions for performing the acts recited in claim 5.

29. A computer readable medium having computer executable instructions for performing the acts recited in claim 6.

30. A computer readable medium having computer executable instructions for performing the acts recited in claim 7.

31. A computer readable medium having computer executable instructions for performing the acts recited in claim 8.
